(19) United States
(12) Patent Application Publication
(10) Pub. No.: US 2006/0220356 A1
(43) Pub. Date: Oct. 5, 2006

(54) INTEGRAL TRIM TETHER SYSTEM FOR VEHICLE APPLICATIONS

(75) Inventor: Matthew Baekelandt, Pontiac, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 10/907,414

(22) Filed: Mar. 31, 2005

(51) Int. Cl. B60R 21/213; B60R 21/215

(52) U.S. Cl. 280/730.2; 280/728.3

(57) ABSTRACT

A trim component retaining assembly (14) includes a trim component (18) and a tether (26). A first portion (50) of the tether (26) is integrally formed with the trim component (18). A fastener (68) is coupled to a second portion (52) of the tether (26) and couples the tether (26) to a vehicle support structure (20). The tether (26) retains the trim component (18) to the vehicle support structure (20) during the deployment of a vehicle restraint (16).

### TECHNICAL FIELD

The present invention relates to vehicle trim and structures and to airbag deployment systems. More particularly, the present invention is related to a method for retaining a trim component during deployment of an airbag.

### BACKGROUND OF THE INVENTION

Airbag deployment systems are commonly used throughout modern vehicles. Airbag deployment systems may include frontal airbags and side airbags, as well as various other types of airbags known in the art. Some example side airbags are door mounted airbags, pillar mounted airbags, and roof rail mounted or side curtain airbags. The stated airbags are typically mounted and housed within or behind various trim components.

It is desirable during an airbag deployment event to retain the trim components adjacent to and displaced by an airbag. The retention of the trim components prevents the projection of objects within a vehicle during a collision event. This prevention aids in averting a potential injury to a vehicle occupant and damage to other vehicle interior components.

Currently, as one example, during the deployment of a roof rail mounted or side curtain airbag a pillar trim cover, covering the airbag, is retained by a trim component retaining assembly. The trim component retaining assembly includes multiple fasteners and a tether, which retain the trim cover. The trim cover is attached to a first end of a tether via a first fastener and a connector, which is sometimes referred to as a “doghouse”, due to its shape and configuration. The connector is attached to the trim component and the first fastener couples the first end to the connector. The second end of the tether in turn is attached to a rigid support structure of a vehicle, such as to a vehicle frame, via a second fastener. The tether is separate from the trim cover and the structure.

During the airbag deployment the trim cover is separated or displaced from the vehicle support structure to allow for the expansion and the intrusion of an airbag into the interior cabin of the vehicle. As the roof rail mounted air bag is deployed the tether retains the trim cover while allowing the airbag to protrude into the interior cabin of the vehicle.

A desires exists to reduce the costs, complexity, and time associated with the assembly and manufacturing of a trim component retaining assembly. Thus, there exists a need for an improved technique of retaining the trim components during the deployment of an airbag.

### SUMMARY OF THE INVENTION

In one embodiment of the present invention, a trim component retaining assembly is provided that includes a trim component and a tether. A first portion of the tether is integrally formed with the trim component. A fastener is coupled to a second portion of the tether and couples the tether to a vehicle support structure. The tether retains the trim component to the vehicle support structure during the deployment of a vehicle restraint.

The embodiments of the present invention provide several advantages. One such advantage is the provision of an integrally formed tether with an associated trim component. This simplifies the number of components utilized to retain a trim component during an airbag deployment event. The reduction in trim component retaining assembly components reduces the costs and assembly times of a trim component retaining assembly and a corresponding airbag system.

Another advantage provided by an embodiment of the present invention is the utilization of a release member coupled to a trim component tether. The release member aids in maintaining the tether in a desired stored position and orientation until retention use thereof.

Additionally, another advantage provided by an embodiment of the present invention is the provision of an integrally formed tether with a trim component in a doghouse configuration. The doghouse configuration provides direct distribution of forces exerted on the tether through multiple attachment points, which aids in maintaining the integral attachment between the tether and the trim component during an airbag deployment event.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a perspective view of an interior cabin of a vehicle incorporating an integrally formed tether and trim component assembly in accordance with an embodiment of the present invention.

FIG. 2 is a perspective and block diagrammatic view of an airbag system of a vehicle incorporating the integrally formed tether and trim component assembly in accordance with an embodiment of the present invention.

FIG. 3A is a side cross-sectional view of an integrally formed tether and trim component with a doghouse configuration in accordance with an embodiment of the present invention.

FIG. 3B is a top view of the tether and trim component of FIG. 3A.

FIG. 4 is a side cross-sectional view of an integrally formed tether and trim component displaced from a vehicle support structure in accordance with an embodiment of the present invention.

FIG. 5 is a logic flow diagram illustrating a method of deploying an airbag within an interior cabin of a vehicle in accordance with an embodiment of the present invention.

### DETAILED DESCRIPTION

In each of the following figures, the same reference numerals are used to refer to the same components. While the present invention is described primarily with respect to a system and method for retaining a trim component during deployment of a roof rail mounted airbag, the present invention may be adapted to various trim components and airbag assemblies and systems. The present invention may be applied to trim components associated with side airbags, curtain airbags, front airbags, and other airbags and deployable restraints known in the art.

In the following description, various operating parameters and components are described for one constructed embodiment. These specific parameters and components are included as examples and are not meant to be limiting.

Also, in the following description the term “vehicle support structure” may refer to any rigid supper member of the vehicle, such as a vehicle frame or a body support structure. The vehicle support structure may be formed of steel, sheet metal, plastic, or other support structure materials known in the art or a combination thereof.

In addition, the term “object” may refer to any animate or inanimate object. An object may be a vehicle, a pedestrian, a lane marker, a road sign, a roadway lane designating line, a vehicle occupant, window moisture, or other object known in the art.

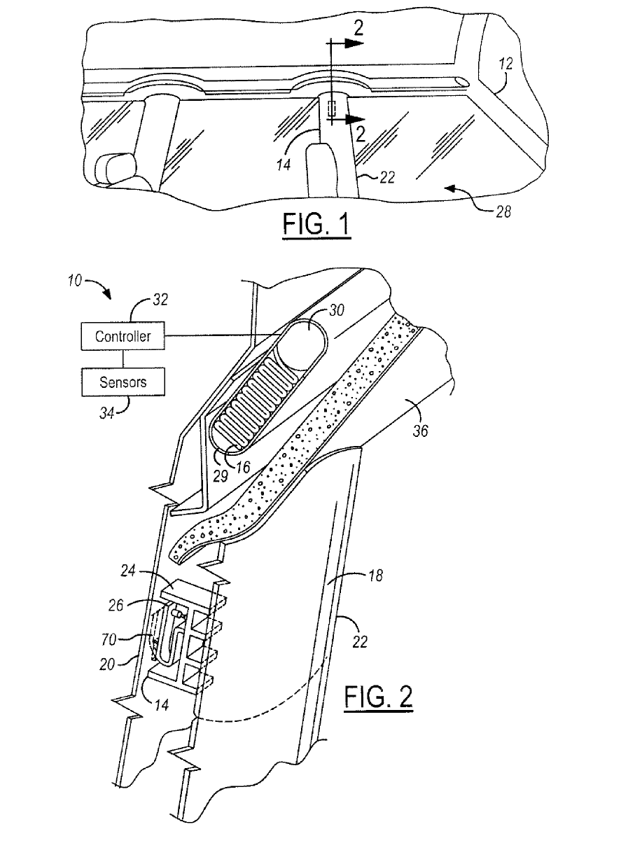

Referring now to FIGS. 1 and 2, perspective and block diagrammatic views of an airbag system 10 of a vehicle 12 incorporating an integrally formed tether and trim component assembly 14 in accordance with an embodiment of the present invention is shown. The airbag system 10 includes a vehicle restraint, such as a roof rail mounted airbag 16, which resides at least partially between the trim component 18 and a vehicle support structure 20. The trim component 18 covers a portion of a pillar 22, such as an A-pillar, a B-pillar, or a C-pillar, of the vehicle 12 when the airbag 16 is stowed. The airbag system 10 also includes a trim component retention assembly 24. The retention assembly 24 includes a tether 26, which is coupled to the trim component 18 and to the vehicle support structure 20. During a collision event the tether 26 restrains and allows the trim component 18 to displace to allow for the expansion of the airbag 16 into the interior cabin 28 of the vehicle 12.

The airbag 16 is contained within an airbag housing 29 and is deployed through the activation of an inflator 30 by a controller 32. The controller 32 detects a collision via one or more sensors 34 and in response thereto activates the inflator 30 to deploy the airbag 16. The airbag 16 resides along a roof rail 36 and may be deployed upon the detection of a side collision, a vehicle role over event, or other warranted airbag deployment situation. A “roof rail” generally refers to any roof structure of the vehicle 12 that extends or is located along the ceiling of the vehicle 12, including portions of a headliner, a roof support structure, a frame, or other roof structure. Although the present invention is described with respect to a trim component that covers a roof rail mounted airbag restraint, the present invention may be modified and applied to other trim components covering other deployable restraints known in the art.

The controller 32 may be microprocessor based such as a computer having a central processing unit, memory (RAM and/or ROM), and associated input and output buses. The controller 32 may be an application-specific integrated circuit or may be formed of other logic devices known in the art. The controller 32 may be a portion of a central vehicle main control unit, an interactive vehicle dynamics module, a restraints control module, a main safety controller, a control circuit having a power supply, or may be a stand-alone controller as shown.

The sensors 34 monitor an environment exterior to the vehicle 12 or a state of the vehicle 12 and generate collision detection signals upon detection of a collision with an object. The sensors 34 may be infrared, vision, ultrasonic, laser, radar, or lidar based or may be in the form of an accelerometer, a piezo electric sensor, a piezo resistive sensor, a charged-coupled device, a series of photodiodes, or in some other form known in the art. The sensors 34 may sense characteristics of an environment external or internal to the vehicle 12. For example, radar sensors may be used to detect an external environment whereas accelerometers may be used to detect an internal environment. The sensors 34 may also be in the form of a pressure sensor or a strain gage. The sensors 34 may be in various locations on the vehicle 12.

The retention assembly 24 in addition to the tether 26 also includes the trim component 18, as well as other components coupled thereto, which are described in more detail below. The tether 26 is integrally formed as part of the trim component 18. In other words, the tether 26 and the trim component 18 are formed as a single integral unit. The tether 26 may be formed of the same materials as that of the trim component 18. The tether 26 may also be formed, shaped, and attached to the trim component 18 such that it directs the direction of displacement of the trim component 18 during a deployment event.

The trim component 18 is shown as one possible example. The trim component 18 may cover a portion of or be part of a vehicle ceiling, an overhead assembly, a door assembly, a console assembly, or some other vehicle assembly containing a deployable restraint. The trim component 18 may be formed of plastic, cloth, leather, vinyl, or other trim materials known in the art or a combination thereof.

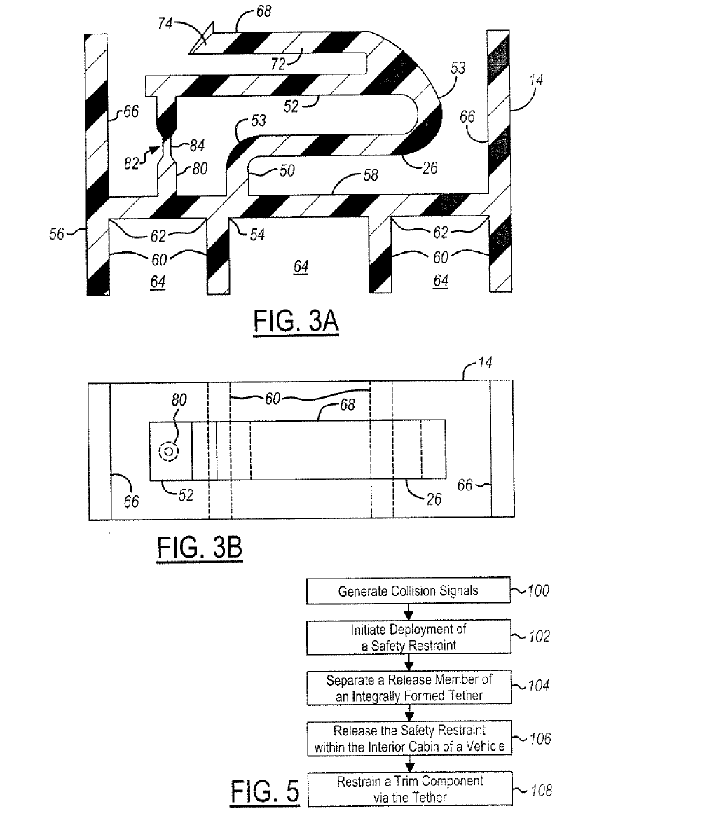

Referring now also to FIGS. 3A and 3B, a side cross-sectional view and a top view of the integrally formed tether and trim component assembly 14 with a doghouse configuration are shown in accordance with an embodiment of the present invention. The tether 26 includes a first end or portion 50 and a second end or portion 52. In the embodiment shown, two bends 53 reside between the portions 50 and 52. The bends 53 provide compact stowage of the tether 26 and may be flexible to allow for the extension of the tether 26. The tether 26 may be of various sizes, lengths, widths, and shapes and have any number of bends. The first portion 50 is attached to and integrally formed as part of a coupling member 54. The coupling member 54, in the embodiment shown, is in a doghouse configuration and has a doghouse base 56. The doghouse base 56 includes a main member 58 having multiple forks or attachment members 60. The attachment members 60 are integrally formed as part of and are attached at multiple attachment points 62 to the coupling member 54. Multiple separation cavities 64 exist between the attachment members 60.

The doghouse base 56 in having multiple attachment members distributes the forces or loads exerted on the first portion 50 during the retention of the trim component 18 in a deployment event. This distribution aids in maintaining the attachment of the tether 26 to the trim component 18. Although a doghouse configuration is shown, the tether 26 may be directly and integrally formed with the trim component 18 without use of the doghouse base 56.

A pair of standoff ribs 66 is also integrally formed as part of the coupling member 54 and extends from the main member 58. The standoff ribs 66 hold the doghouse base 56 or main member 58 at a desired distance away from the vehicle support structure 20. The standoff ribs 66 may be rigid or flexible, may rest against the vehicle support structure 20, or reside partially within slots (not shown) of the vehicle support structure.

A fastener 68 is also integrally formed as part of and is attached to the coupling member 54. During assembly of the airbag system 10 the fastener 68 is clipped into a slot 70, which can be seen in FIG. 2, in the vehicle support structure 20. The fastener 68, in the embodiment shown, is shaped such that it may be extended within the slot 70 during assembly and such that it maintains the coupling between the second portion 52 and the vehicle support structure 20 during a deployment event. The fastener 68 is shaped such that when the trim component 18 is displaced and forces are inwardly exerted on the tether 26 and thus on the fastener 68 that the fastener 68 remains within and does not pull out of the slot 70.

The fastener 68 includes a main element 72 and a hooked end 74. One example fastener is shown in FIG. 3A, of course, other fasteners known in the art may be utilized. The fastener 68 may be in the form of one or more clips, trees, or clasps, or may be in the form of other fasteners known in the art. The fastener 68 may or may not be integrally formed as part of the coupling member 54, however, when integrally formed the number of components utilized is reduced. Although only a single tether, doghouse base, and fastener are shown, any number of each may be utilized. The fastener 68 may be formed of various materials including plastic and metallic materials known in the art.

A release member 80 is also integrally formed as part of and attached to the second portion 52 and the main member 58. The release member 80 holds the tether 26 in a desired position and orientation until displacement of the trim component 18 and extension of the tether 26. The release member 80 may also aid in holding the trim component 18 to the vehicle support structure 20 until separation thereof. In the embodiment shown, the release member 80 is hourglass-shaped and includes a narrowed section 82 with a breakpoint 84. When a predetermined amount of force is exerted on the release member 80 the release member 80 separates at the break point 84, thereby, allowing the tether 26 to extend. The force required to separate the release member 80 is such as not to interfere with or hinder the deployment and performance of the airbag 16.

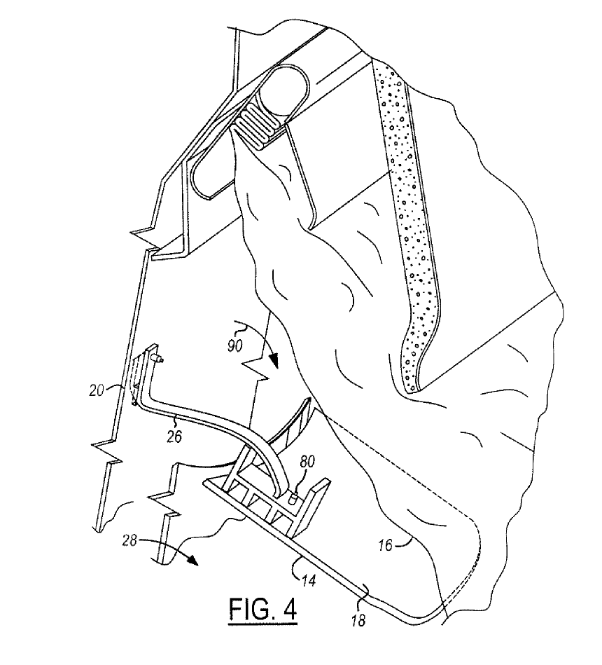

Referring now to FIG. 4, a side cross-sectional view of the integrally formed tether and trim component assembly 14 displaced from the vehicle support structure 20 in accordance with an embodiment of the present invention is shown. The trim component 18 is shown in a displaced position after activation and deployment of the airbag 16. The release member 80 is separated and the tether 26 is extended. The trim component 18 is retained by the tether 26 to the vehicle support structure 20 to prevent projection of the trim component 18 into the interior cabin 28 beyond a distance approximately equal to the length of the tether 26. The desired length of the tether 26 may vary and depends upon the application. Arrow 90, of FIG. 4, designates the direction of displacement of the trim component 18. The trim component 18 is shown in one possible orientation relative to the airbag 16. Of course, other orientations are possible upon deployment.

Referring now to FIG. 5, a logic flow diagram illustrating a method of deploying the airbag 16 within the interior cabin 28 in accordance with an embodiment of the present invention is shown. Although the method of FIG. 5 is primarily described with respect to the embodiments of FIGS. 2-4, it may be easily modified for other embodiments of the present invention.

In step 100, the sensors 34 detect a collision between an object and the host vehicle 12 and generate collision signals. In step 102, the controller 32 in response to the collision signals initiates deployment of a safety restraint, such as the airbag 16. The controller 32 signals the inflator 30 to commence deployment of the airbag 16. The inflator 30, using methods known in the art, inflates the airbag 16 to prevent injury to a vehicle occupant due to the detected collision.

In step 104, the forces exerted by the deployment of the airbag 16 causes the release member 80 to separate, which allows the trim component 18 to displace away from the vehicle support structure 20. The release component 80 separates without affecting the performance, including the deployment rate and the expansion, of the airbag 16.

In step 106, as the trim component 18 separates and translates away from the vehicle support structure 20 the airbag 16 is released within the interior cabin 28 and is utilized in the form of an occupant restraint.

In step 108, the tether 26 limits the outward displacement of the trim component 18. During deployment of the airbag 16 the tether 26 is allowed to extend. The tether 26 retains the trim component 18 within a predetermined distance away from the vehicle support structure 20. The predetermined distance corresponds to the length of the tether 26.

The above-described steps are meant to be illustrative examples; the steps may be performed sequentially, synchronously, simultaneously, or in a different order depending upon the application.

The present invention provides a simplified technique for restraining vehicle trim components during deployment of occupant restraints. The present invention reduced the number of components involved in the retention of a trim component and thus reduced the manufacturing and assembly costs of a trim component retention assembly.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A trim component retaining assembly comprising:
at least one trim component;
at least one tether having a first portion integrally formed with said at least one trim component; and
at least one fastener coupled to a second portion of said at least one tether and coupling said at least one tether to a vehicle support structure;
said at least one tether retaining said at least one trim component to said vehicle support structure during deployment of a vehicle restraint.

2. A trim component retaining assembly as in claim 1 wherein said at least one trim component and said at least one tether are formed of the same material.

3. A trim component retaining assembly as in claim 1 further comprising a coupling member integrally formed with said at least one trim component and said at least one tether, said coupling member attaching said first portion to said at least one trim component.

4. A trim component retaining assembly as in claim 3 wherein said coupling member comprises a doghouse base.

5. A trim component retaining assembly as in claim 4 wherein said doghouse base comprises a plurality of attachment points coupling said coupling member to said at least one trim component.

6. A trim component retaining assembly as in claim 3 wherein said coupling member comprises at least one standoff separating said trim cover from a vehicle support structure.

7. A trim component retaining assembly as in claim 1 further comprising a release member coupled between said at least one trim component and said at least one tether, said release member allowing displacement of said tether during said deployment.

8. A trim component retaining assembly as in claim 7 wherein said release member attaches said second portion to said at least one trim component and comprises a breakpoint, which separates during said deployment.

9. A trim component retaining assembly as in claim 1 further comprising:
a coupling member integrally formed with said at least one trim component and said at least one tether, said coupling member attaching said first portion to said at least one trim component; and
a release member coupled between said coupling member and said at least one tether, said release member allowing displacement of said tether during said deployment.

10. A trim component retaining assembly as in claim 9 wherein said release member attaches said second portion to said coupling member and comprises a breakpoint, which separates during said deployment.

11. A trim component retaining assembly as in claim 1 wherein said at least one fastener is integrally formed with said at least one tether.

12. A trim component retaining assembly as in claim 1 wherein said at least one fastener clips into said vehicle support structure.

13. An airbag system for a vehicle comprising:
at least one trim component;
an airbag housing residing between said at least one trim component and a vehicle support structure and comprising at least one airbag;
at least one tether having a first portion integrally formed with said at least one trim component; and
at least one fastener coupled to a second portion of said at least one tether and attaching said at least one tether to said vehicle support structure;
said at least one tether retaining said at least one trim component during deployment of said at least one airbag.

14. A system as in claim 13 wherein said at least one airbag comprises a roof rail mounted airbag.

15. A system as in claim 13 further comprising a coupling member integrally formed with said at least one trim component and said at least one tether, said coupling member attaching said first portion to said at least one trim component.

16. A system as in claim 15 wherein said coupling member comprises a doghouse base.

17. A system as in claim 13 further comprising a release member coupled between said at least one trim component and said at least one tether, said release member allowing displacement of said tether during an airbag deployment event.

18. A system as in claim 13 further comprising:
a coupling member integrally formed with said at least one trim component and said at least one tether, said coupling member attaching said first portion to said at least one trim component; and
a release member coupled between said coupling member and said at least one tether, said release member allowing displacement of said tether during an airbag deployment event.

19. A method of deploying an airbag within an interior cabin of a vehicle comprising:
initiating deployment of at least one airbag;
allowing displacement of at least one trim component;
releasing said at least one airbag within an interior cabin of a vehicle; and
retaining said at least one trim component via at least one tether integrally formed with said at least one trim component during deployment of said at least one airbag.

20. A method as in claim 19 further comprising separating at least one release member coupling said at least one tether to said at least one trim component.
